(19) United States
(12) Patent Application Publication
(10) Pub. No.: US 2006/0207689 A1
(43) Pub. Date: Sep. 21, 2006

(54) Method for producing sintered rare earth element magnet

(76) Inventors: Makoto Iwasaki, Tokyo (JP); Chikara Ishizaka, Tokyo (JP)

Correspondence Address: KANESAKA BERNER AND PARTNERS LLP, SUITE 300, 1700 DIAGONAL RD, ALEXANDRIA, VA, 22314-2848, US

(21) Appl. No.: 10/541,724

(22) PCT Filed: Oct. 28, 2004
(86) PCT No.: PCT/JP04/16010

§ 371 Date: Apr. 4, 2006

(30) Foreign Application Priority Data
Oct. 31, 2003 (JP) 2003-373673
Oct. 31, 2003 (JP) 2003-373674
Oct. 31, 2003 (JP) 2003-373675

(51) Int. Cl. H01F 41/00

(52) U.S. Cl. 148/105

(57) ABSTRACT

The strength of a compacted body is enhanced without deteriorating the magnetic properties. Additive metal powder is added to raw alloy containing a rare earth element, a transition metal element and boron to obtain a mixture, the mixture is compacted to obtain a compacted body, and the compacted body is sintered to obtain a rare earth sintered magnet. The additive metal powder is at least one species selected from the group consisting of powders of Al, Ni, Zr, Mn, Fe, Co, Cu, Zn, Ag, Sn and Bi. When adopting a process of crushing the raw alloy and a process of pulverizing the crushed raw alloy, the additive metal powder is added after the crushing process or after the pulverizing process. The amount of the additive metal powder added is 0.01 mass % or more. The additive metal powder is preferred to be platy metal alloy and, in this case, the thickness thereof is set to be 10 μm or less.

### TECHNICAL FIELD

The present invention relates to a method for producing a rare earth sintered magnet comprising of a rare earth element, a transition metal element and B (boron) as main components and particularly to technology of improving the strength of a compacted body before being sintered when producing a rare earth sintered magnet in accordance with the powder metallurgy.

### BACKGROUND ART

Of rare earth metal sintered magnets, an Nd—Fe—B-based sintered magnet, for example, has the advantage that it is excellent in the magnetic properties and that the Nd that is the principal component thereof is resourceful and relatively inexpensive. Therefore, there has recently been shown a noticeable trend of further increasing the demand for Nd—Fe—B-based sintered magnets. Under these circumstances, research and development for enhancement of the magnetic properties of Nd—Fe—B-based sintered magnets and improvement in a method for producing high-quality rare earth sintered magnets (refer to Patent Document 1 and Patent Document 2, for example) have been facilitated in various circles.

In the invention described in Patent Document 1, for example, alloy powder is mixed with a lubricant diluted with a specific organic solvent to attain elimination of reduction in strength of a compacted body resulting from the addition of the lubricant. The invention described in Patent Document 2 changes the timing of adding lubricant to attain reduction of wear of crushing and pulverizing equipment while enjoying the effect of enhancing the degree of orientation owing to the addition of the lubricant.

Patent Document 1: JP-A HEI 9-3504

Patent Document 2: JP-A 2003-68551

Known and widely used as a production method of rare earth sintered magnets is powder metallurgy as described in each of the Patent Documents mentioned above because production can be realized at low cost. According to the powder metallurgy, a raw alloy ingot is subjected to a crushing process and a pulverizing process to obtain pulverized raw alloy having a particle size of around several μm. The pulverized raw alloy thus obtained are subjected to magnetic field orientation in the static magnetic field and, in the state of application of the magnetic field, subjected to press compacting. After the press compacting in the magnetic field, the compacted body is sintered in vacuum or in an inert gas atmosphere and then further subjected to aging treatment.

### DISCLOSURE OF THE INVENTION

### Problems the Invention Intends to Solve

By the way, when producing a rare earth sintered magnet in accordance with the powder metallurgy, since the compacted body before being sintered is a pressurized powder body, the strength thereof is weak, resulting in difficulty in producing a compacted body. When the compacted body lacks in strength, cracks and chips are easy to generate in handling the compacted body, thereby reducing the yield.

When producing a rare earth sintered magnet in accordance with the powder metallurgy, it is desirably needed to develop technology of improving the strength of a compacted body. Though Patent Document 1 mentioned above touches upon the strength of a compacted body, the gist thereof is to eliminate the decrease in strength by the addition of a lubricant. Thus, the prior art is focusing on the compacting property and has no idea of positively heighten the strength of a compacted body.

The present invention has been accomplished in view of the conventional state of affairs, and the object thereof is to develop technology enabling the strength of a compacted body to be positively enhanced without deteriorating the magnetic properties thereof and provide a method capable of producing a rare earth sintered magnet excellent in magnetic properties at high yields.

### Means for Solving the Problems

To attain the above object, the present inventors continued various studies for a long period of time and, as a result, came to a conclusion that addition of metal powder (powder of Al, Ni, Zr and Mn, for example) to the pulverized raw alloy was effective. The present invention has been perfected based on this knowledge and provides a method for producing a rare earth sintered magnet, comprising the steps of preparing pulverized raw alloy that comprises R (R is at least one rare earth element, provided that it contains Y), T (T is at least one transition metal element indispensably containing Fe or Fe and Co) and B and has additive metal powder added thereto, compacting the prepared pulverized raw alloy to obtain a compacted body and sintering the compacted body. The additive metal powder is at least one species selected from the group consisting of powders of Al, Ni, Zr and Mn, for example.

By adding the additive powder when compacting the pulverized raw alloy, the strength of a compacted body is enhanced. Particularly when the additive metal powder is in the form of plates, the strength-enhancing effect is made high. Though the detailed reason for this has not yet been made explicit, the effect thereof has been experimentally confirmed. The deterioration of the magnetic properties caused by the additive metal powder is small.

The additive metal powder is to be added between after raw alloy melted and cast is pulverized and before the pulverized alloy is compacted. For example, either the time the cast raw alloy has undergone a crushing process or the time the crushed raw alloy has undergone a pulverizing process will do. The degree of enhancement of the strength of a compacted body will be increased when adding the additive metal powder in an advanced pulverized state of the cast raw alloy. While Al, Zr, Ni and Mn, for example, are known as elements contained in a rare earth sintered magnet, the effect cannot be manifested when adding at least one of the metals at the time of the raw alloy being melted or cast. It is required to add at least one of powders of Al, Zr, Ni and Mn, for example, to the raw alloy powder after the raw alloy that has been melted and cast is crushed or pulverized in order to attain the object of the present invention.

### Effects of the Invention

According to the production method of the present invention, it is possible to enhance the strength of a compacted body before being sintered, make the compacting process easy and suppress the generation of cracks and chips when handling the compacted body. Accordingly, it is possible to reduce the yield reduction resulting from the generation of cracks and chips and efficiently produce rare earth sintered magnets. Furthermore, according to the present invention, it is possible to produce rare earth sintered magnets excellent in magnetic properties, such as the coecivity and the residual magnetic flux density,

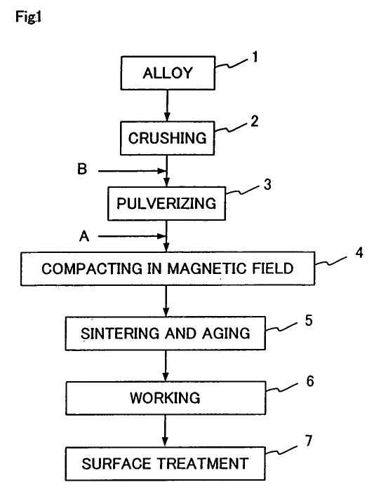

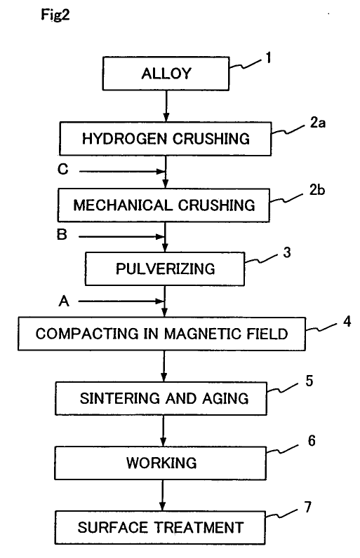

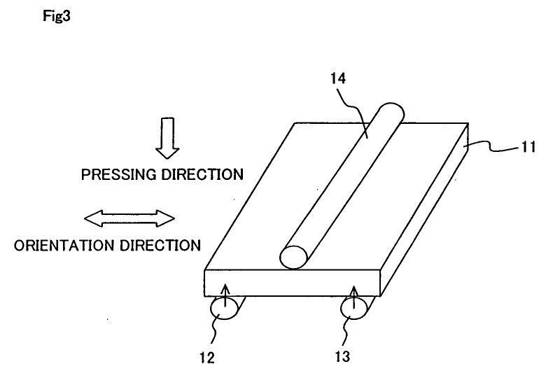

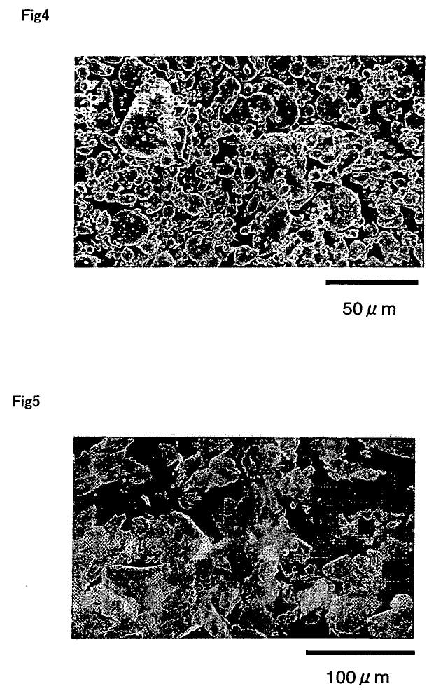

### BRIEF DESCRIPTION OF THE DRAWINGS

[FIG. 1] It is a flow chart showing one example of processes of producing a rare earth sintered magnet.

[FIG. 2] It is a flow chart showing another example of processes of producing a rare earth sintered magnet.

[FIG. 3] It is a schematic perspective view explaining a method for measuring the flexural strength.

[FIG. 4] It is a micrograph of spherical Al powder.

[FIG. 5] It is a micrograph of platy Al powder.

### EXPLANATION OF REFERENCE NUMERALS AND SYMBOLS

1 alloying process, 2 crushing process, 2a hydrogen crushing process, 2b mechanical crushing process, 3 pulverizing process, 4 compacting process in a magnetic field, 5 sintering and aging process, 6 working process, 7 surface treatment process, 11 compacted body, 12, 13 and 14 support implements.

### BEST MODE FOR CARRYING OUT THE INVENTION

A method for producing a rare earth sintered magnet to which the present invention is applied will be described hereinafter in detail with reference to the drawings.

In the production method of the present invention, a rare earth sintered magnet to be produced is composed preponderantly of a rare earth element, a transition metal element and boron. The composition of the magnet can be optionally selected in accordance with the application object thereof.

In the case of a R-T-B-based (R is at least one rare earth element, provided that it contains Y, T is at least one transition metal element indispensably containing Fe or Fe and Co, and B is boron) rare earth sintered magnet, for example, to obtain a rare earth sintered magnet excellent in magnetic properties the composition of a sintered magnet is preferably composed of 20 to 40 mass % of the rare earth element R, 0.5 to 4.5 mass % of B and the balance of the transition metal element T. Here, R is at least one rare earth element selected from the group consisting of Y, La, Ce, Pr, Nd, Sm, Eu, Gd, Tb, Dy, Ho, Er, Yb and Lu. Of these, Nd is resourceful and relatively inexpensive and, therefore, preferably Nd is used as a principal component. Furthermore, since containing Dy increases the anisotropic magnetic field, Dy is effective for enhancing the coecivity Hcj.

Alternatively, an additive element can be added to produce a R-T-B-M-based sintered magnet. As the additive element M, Al, Cr, Mn, Mg, Si, Cu, C, Nb, Sn, W, V, Zr, Ti, Mo, Bi, Ga and the like can be cited. At least one of these selected can be added. The amount of the additive element M to be added is preferably 3 mass % or less in consideration of the magnetic properties, such as the residual magnetic flux density. Excess amount of the additive element M will possibly deteriorate the magnetic properties.

Of course, it goes without saying that present invention is not limited to the compositions mentioned above, but is applicable to the overall compositions conventionally known to the art.

The powder metallurgy is adopted in producing the aforementioned rare earth sintered magnet. The production method of a rare earth sintered magnet by the powder metallurgy will be described hereinafter.

FIG. 1 shows one example of processes for producing a rare earth sintered magnet by the powder metallurgy. The production processes fundamentally comprise an alloying process 1, a crushing process 2, a pulverizing process 3, a compacting process 4 in a magnetic field, a sintering and aging process 5, a working process 6 and a surface treatment process 7. For protection against oxidation, almost all of the processes up to the sintering process are performed preferably in vacuum or in an inert gas atmosphere (such as in an atmosphere of nitrogen or Ar).

In the alloying process 1, raw metals or raw alloys are compounded in accordance with the composition of a magnet, melted in vacuum or an atmosphere of an inert gas, such as Ar, and cast to obtain an alloy cast. As a casting method, a strip casting method (a continuous casting method) that comprises supplying a high-temperature molten metal solution onto a rotating roll and continuously casting a thin alloy plate is advantageously used from the viewpoint of productivity etc. However, the strip casting method is by no means limitative in the present invention. As raw metals (alloys), pure rare earth elements, rare earth alloys, pure iron, ferroboron and alloys of these can be used. For the purpose of eliminating solidification segregation, a homogenizing treatment may be adopted when necessary. The solution treatment conditions include retention in vacuum or in an Ar atmosphere at a temperature range of 700 to 1500° C. for a period of 1 hour or more, for example.

A single alloy having a composition substantially the same as a final magnet composition may be used, or a plurality of alloys of different compositions may be mixed so that the mixed alloys have the final magnet composition. Though the mixing can be performed in any one of the alloying, raw material crushing and raw material pulverizing steps, mixing in the alloying process is desirable in view of the mixing uniformity.

In the crushing process 2, the thin raw alloy plate cast previously or an alloy ingot is crushed into particles until the particle size becomes several hundred μm. As the crushing means, a stamp mill, jaw crusher, Braun mill, etc. can be used.

The crushing process 2 can be constituted by a plurality of crushing processes combining a plurality of crushing means. FIG. 2 illustrates an example the crushing process 2 comprises two processes, one being a hydrogen crushing process 2a and the other being a mechanical crushing process 2b. The hydrogen crushing process 2a enables a cast raw alloy to abosrb hydrogen to crush the alloy in a self-disintegrated manner utilizing the difference in amount of the hydrogen abosrbed in different phases of the alloy. With this, the alloy can be crushed to a particle size of around several mm. The mechanical crushing process 2b utilizes a mechanical means, such as a Braun mill etc., as described above to crush the alloy particles crushed to the particle size of around several mm through the hydrogen crushing process 2a to a particle size of around several hundred μm. In order to enhance the crushing property, it is effective to perform crushing in combination with the hydrogen crushing process. When performing the hydrogen crushing process 2a, the mechanical crushing process 2b can be omitted.

After completion of the crushing process 2, the crushed raw alloy are added with a grinding aid. As the pulverizing aid, fatty acid-based compounds can be used, for example. Particularly, use of fatty acid amide as the grinding aid enables rare earth sintered magnets having good magnetic properties to be obtained. Preferably, the amount of the grinding aid to be added is in the range of 0.03 to 0.4 mass %. When adding the grinding aid within this range, the amount of the residual carbon in the alloy that has undergone sintering can be reduced and, therefore, this is effective in enhancing the magnetic properties of a rare earth sintered magnet.

The pulverizing process 3 is executed using a jet mill, for example, upon completion of the crushing process 2. The pulverizing conditions may appropriately be set depending on the kind of a jet-flow pulverizer used, and the crushed raw alloy is pulverized to a mean particle size in the range of around 1 to 10 μm, e.g., 3 to 6 μm. The jet mill jets a highly pressurized inert gas (nitrogen gas, for example) from its constricted nozzle to generate a high-speed gas flow and accelerate the pulverized particles, thereby giving rise to collision among the particles and collision of the particles against a target or container wall to attain pulverization. The jet mill is generally classified into jet mills utilizing a fluidized bed, jet mills utilizing eddy currents, jet mills using a collision plate.

In the compacting process 4 in a magnetic field after the pulverizing process 3, the pulverized raw alloy is compacted in a magnetic field. To be specific, the pulverized raw alloy obtained through the pulverizing process 3 is filled in a mold in which electromagnets are arrayed, and compacted in a magnetic field, with a state of the crystallographic axis being oriented by application of a magnetic field maintained. The compacting in the magnetic field can be performed through either longitudinal magnetic compacting or transversal magnetic compacting. This compacting in the magnetic field is performed under a pressure of around 130 to 160 MPa in a magnetic field in the range of 800 to 1,500 kA/m, for example.

Sintering and aging treatment is then carried out in the sintering and aging process 5. That is, the compacted body obtained in the compacting of the pulverized raw alloy in the magnetic field is sintered in vacuum or in an inert gas atmosphere. Though the sintering temperature has to be adjusted taking into consideration various conditions, such as an alloy composition, crushing and pulverizing methods, a particle size, particle size distribution, etc., sintering can be completed at a temperature in the range of 1,000 to 1,150° C. for around 5 hours. Preferably, the sintered body is quenched. The sintered body obtained through sintering is preferably subjected to aging treatment. This aging treatment is a process important to control the coecivity Hcj of a rare earth sintered magnet to be obtained and is performed, for example, in an inert gas atmosphere or in vacuum. Preferable as the aging treatment is a two-stage aging treatment is preferred. The sintered body is retained at a temperature of around 800° C. for 1 to 3 hours in a first stage aging treatment. A first quenching process is provided for quenching the sintered body to within a range of normal room temperature to 200° C. In a second-stage aging treatment, the sintered body having undergone the first quenching treatment is retained at around 550° C. for 1 to 3 hours. A second quenching process is provided for quenching the sintered body thus aged to normal room temperature. Since the coecivity Hcj is greatly increased at a heat treatment in the neighborhood of 600° C., when a one-stage aging treatment is adopted, the aging treatment is performed preferably in the neighborhood of 600° C.

After the sintering and aging process, the working process 6 and surface treatment process 7 are performed. The working process 6 is to mechanically form the aged body into a desired shape. The surface treatment process 7 is a process to suppress oxidation of the rare earth sintered magnet obtained, such as to form on the surface of the rare earth sintered magnet a plated overcoat or a resin overcoat.

In the producing processes described above, additive metal powder is added as a compacting aid to the pulverized raw alloy in the present invention and the resultant mixture is compacted in the compacting process 4 in a magnetic field. Powder of metals can optionally be used as the additive metal powder. Examples of the metals include Al, Mn, Fe, Co, Ni, Cu, Zn, Zr, Ag, Sn and Bi. At least one metal powder can selectively be used. Of these, powders of Al, Ni, Zr and Mn are preferred. It is advantageous that at least one of the four species selected is added as the compacting aid.

The addition of the additive metal powder is performed between the crushing process after the alloying process 1 in which the raw alloy is melted and cast and the compacting process 4 in a magnetic field in which the pulverized raw alloy is compacted. In the case of the producing processes shown in FIG. 1, for example, the addition is performed after the pulverizing process 3 (at the addition timing A in the figure) or after the crushing process 2 (at the addition timing B in the figure). In the case of the producing processes shown in FIG. 2, the addition is performed after the pulverizing process 3 (at the addition timing A in the figure), after the mechanical crushing process 2b (at the addition timing B in the figure) or after the hydrogen crushing process 2a (at the addition timing C in the figure).

Though the addition timing of the additive metal powder may fundamentally be any one of these, a higher effect can be manifested by the addition after the advanced degree of pulverization. The highest effect can be manifested, for example, when the additive metal powder is added to the raw alloy powder immediately before the compacting process. Therefore, in the producing processes shown in FIG. 1, for example, the effect is higher after the pulverizing process 3 (at the addition timing A) than after the crushing process 2 (at the addition timing B). In the producing processes shown in FIG. 2, similarly, the effect is higher after the mechanical crushing process 2a (at the addition timing B) than after the hydrogen crushing process 2a (at the addition timing C) and is further higher after the pulverizing process 3 (at the addition timing A) than the mechanical crushing process 2a (at the addition timing B).

The additive metal powder can be mixed by a conventional mixing method, such as a method using a V mixer, ribbon mixer, etc. Any prior art method may be adopted insofar as uniform mixing can be ensured.

The amount of the additive metal powder is preferably 0.01 mass % or more, more preferably 0.02 mass % or more, based on the amount of the pulverized raw alloy. When the amount of the additive metal powder is less than 0.01 mass %, a sufficient effect is difficult to obtain, provided that he amount is preferably 0.5 mass % or less in consideration of deterioration of the magnetic properties. When the amount of the additive metal powder exceeds 0.5 mass %, there is a fair possibility of a problem of deteriorating the magnetic properties arising.

The optimum amount of the additive metal powder varies depending on the kind of the additive metal powder. For example, the optimum amount of Al powder is 0.15 mass % or more and 0.3 mass % or less, that of Ni powder is in the range of 0.02 mass % to 0.08 mass % inclusive, that of Zr powder is in the range of 0.15 mass % to 0.3 mass % inclusive, and that of Mn powder is in the range of 0.02 mass % to 0.25 mass % inclusive.

The mean particle size of the additive metal powder is optional and is appropriately selected in accordance with the particle size of the pulverized raw alloy. Preferably, the mean particle size of the additive metal powder is 50 μm or less, more preferably 10 μm or less.

While the shape of the additive metal powder is also optional, the effect is heightened when the shape is platy. Therefore, it is preferred to use platy metal powder having a prescribed thickness, like scale pieces etc., for example. The platy powder can easily be discriminated through observation of powder by means of a microscope etc. With respect to the platy metal powder, though the platy ratio (plate surface size/plate thickness), particle size and thickness are optional, preferably, the platy ratio is in the range of 2 to 15 inclusive, and the plate surface size is preferably 50 μm or less, more preferably 10 μm or less. What is important among others is the thickness of the platy metal powder. It is preferably 10 μm or less, more preferably 3 μm or less. Use of the powder having a smaller thickness enables the effect to be further manifested.

Since the additive metal powder to be added is alloyed with the raw alloy after sintering, it does not adversely affect the properties of a rare earth sintered magnet obtained insofar as the amount thereof is within the prescribed one.

### EXAMPLES

Examples of the present invention will be described based on the results of experiments.

Production of Rare Earth Sintered Magnets

The composition of the raw alloy was set to comprise 24.5 mass % of Nd, 6.0 mass % of Pr, 1.8 mass % of Dy, 0.5 mass % of Co, 0.2 mass % of Al, 0.07 mass % of Cu, 1.0 mass % of B and the balance of Fe. The raw metals were, or alloy was, compounded to obtain the above composition. The raw metals were, or alloy was, melted and cast by strip casting method to obtain a raw thin alloy plate.

The raw thin alloy plate was subjected to hydrogen crushing process and then mechanically crushed with a Braun mill to obtain crushed raw alloy. To the crushed raw alloy, 0.1 mass % of oleic amide was added as a grinding aid. A jet-flow pulverizer (jet mill) was used to perform pulverization of the mixture, thereby obtaining pulverized raw alloy having the mean particle size D50=4.1 μm.

Additive powder was added to and mixed with the pulverized raw alloy in a mortar. The pulverized particles obtained were compacted in a magnetic filed to obtain a compacted body of a predetermined shape. This compacting in the magnetic field was performed under a compacting pressure of 147 MPa in the magnetic field of 1,200 kA/m. The direction of the magnetic field applied was orthogonal to the direction of pressing.

The compacted body obtained in the compacting process in the magnetic field was sintered and subjected to aging treatment to produce samples 1 to 9. The sintering was performed in vacuum at a sintering temperature of 1,030° C. for 4 hours. As the aging treatment, two-stage aging treatment was adopted, that comprises a first stage at 900° C. for 1 hour and a second stage at 530° C. for 1 hour.

Evaluation

In the production of the aforementioned rare earth sintered magnet, the compacted body obtained by the compacting process in the magnetic field was first measured with respect to its flexural strength. The flexural strength measurement was carried out pursuant to Japanese Industrial Standards JIS R 1601. Specifically, as shown in FIG. 3, a load was exerted onto the compacted body 11 placed on two support implements 12 and 13 in the shape of a round bar, with a support implement 14 also in the shape of a round bar disposed on the compacted body 11 at the center thereof. The chip size of the compacted body was measured 20 mm×18 mm×6 mm. Further, the direction of flexural pressure applied was the pressing direction.

Each of the rare earth sintered magnets was measured with respect to its coecivity Hcj and residual magnetic flux density Br. This measurement was performed using a B-H tracer.

Affection of Addition of Al Powder (Spherical Powder) on Strength and Magnetic Properties of Compacted Body

In accordance with the production of rare earth sintered magnets as described above, spherical Al powder was used as an additive metal powder, and samples 1-1 to 1-11 were produced, with the amount of the added spherical Al powder varied as shown in Table 1. The micrograph of the spherical Al powder used is as shown in FIG. 4. Further, the particle size of Al powder used for samples 1-1 to 1-9 was 20 μm and that for samples 10 and 11 was 40 μm. The amount of spherical Al powder added, magnet Al composition, flexural strength of the compacted body (compacted body strength) and magnetic properties (coecivity Hcj and residual magnetic flux density Br are shown in Table 1.

TABLE 1

| | | | Com- | | |
|---|---|---|---|---|---|
| | Amount of | | pacted | | Residual |
| | Al Powder | Magnet Al | Body | | magnetic |
| | Added | Composition | Strength | Coecivity | flux density |
| Sample | (mass %) | (mass %) | (MPa) | Hcj (kA/m) | Br (T) |
| 1-1 | 0.00 | 0.20 | 0.50 | 1281 | 1.35 |
| 1-2 | 0.01 | 0.21 | 0.50 | 1282 | 1.35 |
| 1-3 | 0.02 | 0.22 | 0.51 | 1287 | 1.35 |
| 1-4 | 0.05 | 0.25 | 0.51 | 1302 | 1.35 |
| 1-5 | 0.10 | 0.30 | 0.54 | 1369 | 1.34 |
| 1-6 | 0.20 | 0.40 | 0.57 | 1416 | 1.33 |
| 1-7 | 0.50 | 0.70 | 0.62 | 1528 | 1.31 |
| 1-8 | 0.60 | 0.80 | 0.63 | 1568 | 1.28 |
| 1-9 | 1.00 | 1.20 | 0.66 | 1600 | 1.18 |
| 1-10 | 0.10 | 0.30 | 0.53 | 1371 | 1.34 |
| 1-11 | 0.20 | 0.40 | 0.56 | 1418 | 1.33 |

It is clear from Table 1 that the flexural strength of the compacted body is enhanced through the addition of spherical Al powder. The more the amount of the spherical Al powder added, the larger the enhancement of the flexural strength of the compacted body is. Therefore, the addition of spherical Al powder before the compacting process in the magnetic field proves effective. On the other hand, as regards the magnetic properties, no level reduction that is particularly problematic cannot be found when the amount of the spherical Al powder is 0.5 mass % or less. When the amount of the spherical Al powder added exceeds 0.5 mass %, however, the deterioration of the residual magnetic flux density Br is gradually made large.

Study on Timing of Adding Al Powder

Rare earth sintered magnets were produced in accordance with the aforementioned production method, with the timing of adding the spherical Al powder varied. The amount of the spherical Al powder added was 0.20 mass %. The timing of adding the spherical Al powder was after the hydrogen crushing process (for sample 1-12), after the crushing by a Braun mill (for sample 1-13) and after the pulverization by a jet mill (for sample 1-14). For the purpose of comparison, a sample in which Al was added to the alloy composition in an amount corresponding to the amount of the spherical Al powder added (sample 1-15) was produced. Also with respect to these samples, the strength of the compacted body and magnetic properties (coecivity Hcj and residual magnetic flux density Br) were measured. The results thereof are shown in Table 2.

TABLE 2

| | | | Com- | | |
|---|---|---|---|---|---|
| | Amount of | | pacted | | Residual |
| | Al Powder | Magnet Al | Body | | magnetic |
| | Added | Composition | Strength | Coecivity | flux density |
| Sample | (mass %) | (mass %) | (MPa) | Hcj (kA/m) | Br (T) |
| 1-12 | 0.20 | 0.40 | 0.54 | 1425 | 1.33 |
| 1-13 | 0.20 | 0.40 | 0.55 | 1420 | 1.33 |
| 1-14 | 0.20 | 0.40 | 0.57 | 1416 | 1.33 |
| 1-15 | 0.00 | 0.40 | 0.50 | 1430 | 1.33 |

As is clear from Table 2, while the compacted body strength is enhanced in any of the samples by the addition of the spherical Al powder, the effect thereof is enhanced in proportion as the addition is made in a later stage. That is to say, the enhancement in compacted body strength is larger in sample 1-13 than sample 1-12 and larger in sample 1-14 than sample 1-13. Sample 1-15 containing Al powder in the alloy composition shows no change in compacted body strength as compared with sample 1-1 having no spherical Al powder added thereto, thus recognizing no effect with respect to the compacted body strength. Also in the same Al composition, no discernible change in magnetic properties can be found even at different timings of the Al addition.

Comparison of Addition of Al to Raw Alloy Composition with Addition of Al Powder at Compacting Process

The difference in magnetic properties between the case where Al powder was added as the additive metal powder and the case where Al was contained in the alloy composition was investigated. Four samples were produced, 1-16 that had 0.2 mass % of Al contained in the raw alloy composition and 0 mass % of additive Al powder, 1-17 that had 0.2 mass % of Al contained in the raw alloy composition and 0.2 mass % of additive Al powder, 1-18 that had 0 mass % of Al contained in the raw alloy composition and 0.2 mass % of additive Al powder and 1-19 that had 0 mass % of Al contained in the raw alloy composition and 0 mass % of additive Al powder. Though it is noted that sample 1-16 is identical with sample 1-1 and that sample 1-17 is identical with sample 1-6, such different sample numbers are given for the sake of simplicity of comparison with other samples. The raw alloy Al composition, amount of Al powder added, compacted body strength, coecivity Hcj and residual magnetic flux density Br of each sample are shown in Table 3.

TABLE 3

| | | Amount | Com- | | Residual |
|---|---|---|---|---|---|
| | | of Al | pacted | | magnetic |
| | Raw Alloy Al | Powder | Body | Coecivity | flux density |
| | Composition | Added | Strength | Hcj | Br |
| Sample | (mass %) | (mass %) | (MPa) | (kA/m) | (T) |
| 1-16 | 0.2 | 0 | 0.5 | 1281 | 1.35 |
| 1-17 | 0.2 | 0.2 | 0.57 | 1416 | 1.33 |
| 1-18 | 0 | 0.2 | 0.57 | 1285 | 1.35 |
| 1-19 | 0 | 0 | 0.5 | 1103 | 1.37 |

As is clear from the comparison between the results of samples 1-16 and 1-18 that are identical in magnet Al composition, the values of the coecivity Hcj and residual magnetic flux density Br of the two samples are substantially the same. In respect of the compacted body strength, the case of adding the spherical Al powder as the additive is larger. Thus, when the amount of the additive before the compacting process is the same as the amount contained in the alloy (i.e., when the corresponding amount of Al is added before the compacting process to the raw alloy having no Al composition), the alloy characteristics other than the compacted body strength do not change. It is, therefore, found that the addition of spherical Al powder before the compacting process is advantageous.

Affection of Addition of Al Powder (Platy Powder) on Compacted Body Strength and Magnetic Properties

Samples 1-20 to 1-28 were produced, with platy Al powder added as the additive Al powder in the amounts shown in Table 4. FIG. 5 is a micrograph of the platy Al powder used. Further, the platy Al powder used had a plate surface size of 40 μm and a thickness of 3 μm. The amount of platy Al powder added, compacted body strength and magnetic properties (coecivity Hcj and residual magnetic flux density Br) in each sample are shown in Table 4.

TABLE 4

| | | | Com- | | |
|---|---|---|---|---|---|
| | Amount of | | pacted | | Residual |
| | Al Powder | Magnet Al | Body | | magnetic |
| | Added | Composition | Strength | Coecivity | flux density |
| Sample | (mass %) | (mass %) | (MPa) | Hcj (kA/m) | Br (T) |
| 1-20 | 0.00 | 0.20 | 0.50 | 1281 | 1.35 |
| 1-21 | 0.01 | 0.21 | 0.51 | 1283 | 1.35 |
| 1-22 | 0.02 | 0.22 | 0.53 | 1289 | 1.35 |
| 1-23 | 0.05 | 0.25 | 0.55 | 1305 | 1.35 |
| 1-24 | 0.10 | 0.30 | 0.58 | 1373 | 1.34 |
| 1-25 | 0.20 | 0.40 | 0.65 | 1420 | 1.33 |
| 1-26 | 0.50 | 0.70 | 0.69 | 1529 | 1.31 |
| 1-27 | 0.60 | 0.80 | 0.71 | 1570 | 1.28 |
| 1-28 | 1.00 | 1.20 | 0.75 | 1605 | 1.18 |

As is clear from Table 4, the addition of platy Al powder enables the flexural strength of the compacted body to be enhanced, and it is found that the effect thereof is higher than that in the addition of spherical Al powder.

Study on Thickness of Platy Al Powder

As the additive metal powder, 0.20 mass % of platy Al powder was added. Samples 1-29 to 1-33 were produced, with the thickness of the platy Al powder varied. The thickness of the platy Al powder, flexural strength of the compacted body and magnetic properties (coecivity Hcj and residual magnetic flux density Br) of each sample are shown in Table 5.

TABLE 5

| | Platy Al | | Compacted | | Residual |
|---|---|---|---|---|---|
| | Powder | Magnet Al | Body | Coecivity | magnetic |
| Sam- | Thickness | Composition | Strength | Hcj | flux density |
| ple | (μm) | (mass %) | (MPa) | (kA/m) | Br (T) |
| 1-29 | 1 | 0.4 | 0.67 | 1421 | 1.33 |
| 1-30 | 3 | 0.4 | 0.65 | 1420 | 1.33 |
| 1-34 | 10 | 0.4 | 0.63 | 1419 | 1.33 |
| 1-32 | 15 | 0.4 | 0.58 | 1416 | 1.33 |
| 1-33 | 20 | 0.4 | 0.57 | 1418 | 1.33 |

As is clear from Table 5, when the thickness of the platy Al powder is 10 μm or less, further enhancement of the flexural strength can be confirmed. It is found, therefore, that it is effective that the thickness of the platy Al powder is set to be 10 μm or less.

Affection of Addition of Ni Powder (Spherical Powder) on Compacted Body Strength and Magnetic Properties

In accordance with the production of rare earth sintered magnets as described above, samples 2-1 to 2-9 were produced using spherical Ni powder as the additive metal powder (particle size: 2 μm), with the amount of the spherical Ni powder varied as shown in Table 1. The amount of the spherical Ni powder added, flexural strength (compacted body strength) and magnetic properties (coecivity Hcj and residual magnetic flux density Br) in each sample are shown in Table 6.

TABLE 6

| | Amount of Ni | Compacted | | Residual |
|---|---|---|---|---|
| | Powder | Body | | magnetic |
| | Added | Strength | Coecivity Hcj | flux density Br |
| Sample | (mass %) | (MPa) | (kA/m) | (T) |
| 2-1 | 0.00 | 0.50 | 1281 | 1.35 |
| 2-2 | 0.01 | 0.51 | 1282 | 1.35 |
| 2-3 | 0.02 | 0.58 | 1285 | 1.35 |
| 2-4 | 0.05 | 0.60 | 1289 | 1.35 |
| 2-5 | 0.08 | 0.58 | 1292 | 1.35 |
| 2-6 | 0.10 | 0.57 | 1297 | 1.35 |
| 2-7 | 0.20 | 0.57 | 1337 | 1.35 |
| 2-8 | 0.50 | 0.56 | 1305 | 1.34 |
| 2-9 | 0.60 | 0.53 | 1257 | 1.34 |

It is clear from Table 6 that the flexural strength of the compacted body is enhanced through the addition of the spherical Ni powder. The enhancement of the flexural strength comes to the peak around the amount of 0.05 mass % of spherical Ni powder added and shows a degradation tendency at the amounts more than that amount. On the other hand, as regards the magnetic properties, the more the amount of the spherical Ni powder added, the larger the degree of enhancement of the magnetic properties, particularly of the coecivity Hcj, is. It can be found from these that the amount of the spherical Ni powder is preferably 0.02 mass %, more preferably in the range of 0.02 to 0.08 mass % inclusive.

Study on Timing of Addition of Ni Powder

In accordance with the production method as described above, rare earth sintered magnets were produced, with the timing of adding the spherical Ni powder varied. The amount of the spherical Ni powder added was 0.05 mass %. The timing of adding the spherical Ni powder was after the hydrogen crushing (sample 2-10), after crushing by a Braun mill (sample 2-11) and after pulverizing by a jet mill (sample 2-12). For the purpose of comparison, a sample having the amount of Ni powder corresponding to the added amount of Ni powder added to the alloy composition (sample 2-13) was also produced. The flexural strength and magnetic properties (coecivity Hcj and residual magnetic flux density Br) of these samples were similarly measured. The results thereof are shown in Table 7.

TABLE 7

| | Amount of Ni | Compacted | | Residual |
|---|---|---|---|---|
| | Powder | Body | | magnetic |
| | Added | Strength | Coecivity Hcj | flux density Br |
| Sample | (mass %) | (MPa) | (kA/m) | (T) |
| 2-10 | 0.05 | 0.55 | 1285 | 1.35 |
| 2-11 | 0.05 | 0.58 | 1288 | 1.35 |
| 2-12 | 0.05 | 0.60 | 1289 | 1.35 |
| 2-13 | *0.05 | 0.50 | 1286 | 1.35 |

*Contained in an alloy composition

As is clear from Table 7, while the compacted body strength is enhanced in any of the samples by the addition of the Ni powder, the effect thereof is enhanced in proportion as the addition is made in a later stage. That is to say, the enhancement in compacted body strength is larger in sample 2-11 than sample 2-10 and larger in sample 2-12 than sample 2-11. Sample 2-13 containing Ni powder in the alloy composition shows no change in compacted body strength as compared with sample 2-1 having no spherical Ni powder added thereto, thus recognizing no effect with respect to the compacted body strength.

Affection of Addition of Ni Powder (Platy Powder) on Compacted Body Strength and Magnetic Properties

Samples 2-14 to 2-22 were produced, with platy Ni powder added as additive metal powder in the amounts shown in Table 8. Incidentally, the platy Ni powder was 10 μm in plate surface size and 2 μm in thickness. The amount of the used platy Ni powder added, flexural strength of the compacted body and magnetic properties (coecivity Hcj and residual magnetic flux density Br) are shown in Table 8.

TABLE 8

| | Amount of Ni | Compacted | | Residual |
|---|---|---|---|---|
| | Powder | Body | | magnetic |
| | Added | Strength | Coecivity Hcj | flux density Br |
| Sample | (mass %) | (MPa) | (kA/m) | (T) |
| 2-14 | 0.00 | 0.50 | 1281 | 1.35 |
| 2-15 | 0.01 | 0.51 | 1282 | 1.35 |
| 2-16 | 0.02 | 0.60 | 1286 | 1.35 |
| 2-17 | 0.05 | 0.65 | 1289 | 1.35 |
| 2-18 | 0.08 | 0.61 | 1294 | 1.35 |
| 2-19 | 0.10 | 0.58 | 1300 | 1.35 |
| 2-20 | 0.20 | 0.57 | 1342 | 1.35 |
| 2-21 | 0.50 | 0.57 | 1320 | 1.34 |
| 2-22 | 0.60 | 0.55 | 1261 | 1.34 |

As is clear from Table 8, the addition of platy Ni powder enables the flexural strength of the compacted body to be enhanced, and it is found that the effect thereof is higher than that in the addition of spherical Ni powder.

Study on Thickness of Platy Ni Powder

As the additive metal powder, 0.05 mass % of platy Ni powder was added. Samples 2-23 to 2-27 were produced, with the thickness of the platy Ni powder varied. The thickness of the platy Ni powder, flexural strength of the compacted body and magnetic properties (coecivity Hcj and residual magnetic flux density Br) of each sample are shown in Table 9.

TABLE 9

| | Platy Ni | | | Residual |
|---|---|---|---|---|
| | Powder | Compacted | | magnetic |
| | Thickness | Body Strength | Coecivity Hcj | flux density Br |
| Sample | (μm) | (MPa) | (kA/m) | (T) |
| 2-23 | 1 | 0.66 | 1300 | 1.35 |
| 2-24 | 3 | 0.65 | 1289 | 1.35 |
| 2-25 | 10 | 0.64 | 1285 | 1.35 |
| 2-26 | 15 | 0.61 | 1285 | 1.35 |
| 2-27 | 20 | 0.61 | 1275 | 1.35 |

As is clear from Table 9, further considerable enhancement of the flexural strength is recognized when the thickness of the platy Ni powder is set to 10 μm or less. It is found, therefore, that it is effective that the thickness of the platy Ni powder is set to be 10 μm or less.

Affection of Addition of Zr Powder (Spherical Powder) on Compacted Body Strength and Magnetic Properties

Samples 3-1 to 3-9 were produced in accordance with the production of rare earth sintered magnets as described above, with spherical Zr powder (particle size: 15 μm) used as the additive metal powder and the amount of the added spherical Zr powder varied as shown in Table 10. The amount of the spherical Zr powder added, flexural strength of the compacted body (compacted body strength) and magnetic properties (coecivity Hcj and residual magnetic flux density Br) of each sample are shown in Table 10.

TABLE 10

| | Amount of Zr | Compacted | | Residual |
|---|---|---|---|---|
| | Powder | Body | | magnetic |
| | Added | Strength | Coecivity Hcj | flux density Br |
| Sample | (mass %) | (MPa) | (kA/m) | (T) |
| 3-1 | 0.00 | 0.50 | 1281 | 1.35 |
| 3-2 | 0.01 | 0.51 | 1282 | 1.35 |
| 3-3 | 0.02 | 0.51 | 1282 | 1.35 |
| 3-4 | 0.05 | 0.51 | 1283 | 1.35 |
| 3-5 | 0.10 | 0.51 | 1296 | 1.35 |
| 3-6 | 0.20 | 0.53 | 1306 | 1.35 |
| 3-7 | 0.50 | 0.63 | 1332 | 1.33 |
| 3-8 | 0.60 | 0.65 | 1335 | 1.33 |
| 3-9 | 1.00 | 0.71 | 1288 | 1.31 |

It is clear from Table 10 that the flexural strength of the compacted body is enhanced through the addition of Zr powder. The more the amount of the Zr powder added, the larger the enhancement of the flexural strength of the compacted body is. Therefore, the addition of Zr powder before the compacting process in the magnetic field proves effective. On the other hand, as regards the magnetic properties, no level reduction that is particularly problematic cannot be found when the amount of the Zr powder is 0.5 mass % or less. When the amount of the Zr powder added exceeds 0.5 mass %, however, the deterioration of the magnetic properties is gradually made large.

Study on Timing of Adding Zr Powder

In accordance with the producing method described above, rare earth sintered magnets were produced, with the timing of adding Zr powder varied. Further, platy Zr powder was used here. The platy Zr powder had a plate surface size of 15 μm and a thickness of 3 μm. In addition, the amount of the platy Zr powder added was 0.20 mass %. The timing of adding the platy Zr powder was after the hydrogen crushing (sample 3-10), after crushing by Braun mill (sample 3-11) and after pulverizing by a jet mill (sample 3-12). For the purpose of comparison, a sample having the amount of Zr powder corresponding to the added amount of Zr powder added to the alloy composition (sample 3-13) was also produced. The flexural strength and magnetic properties (coecivity Hcj and residual magnetic flux density Br) of these samples were similarly measured. The results thereof are shown in Table 11.

TABLE 11

| | Amount of Zr | Compacted | | Residual |
|---|---|---|---|---|
| | Powder | Body | | magnetic |
| | Added | Strength | Coecivity Hcj | flux density Br |
| Sample | (mass %) | (MPa) | (kA/m) | (T) |
| 3-10 | 0.20 | 0.52 | 1308 | 1.35 |
| 3-11 | 0.20 | 0.54 | 1310 | 1.35 |
| 3-12 | 0.20 | 0.56 | 1315 | 1.35 |
| 3-13 | *0.20 | 0.50 | 1312 | 1.35 |

*Contained in an alloy composition

As is clear from Table 11, while the compacted body strength is enhanced in any of the samples by the addition of the Zr powder, the effect thereof is enhanced in proportion as the addition is made in a later stage. That is to say, the enhancement in compacted body strength is larger in sample 3-11 than sample 3-10 and larger in sample 3-12 than sample 3-11. Sample 3-13 containing Zr powder in the alloy composition shows no change in compacted body strength as compared with sample 3-1 having no Zr powder added thereto, thus recognizing no effect with respect to the compacted body strength.

Affection of Addition of Zr Powder (Platy Powder) on Compacted Body Strength and Magnetic Properties

Samples 3-14 to 3-22 were produced, with plate Zr powder used as additive metal powder in the amounts shown in Table 12. Further, the platy Zr powder had a plate surface size of 15 μm and a thickness of 3 μm. The amount of the platy Zr powder added, flexural strength of the compacted body and magnetic properties (coecivity Hcj and residual magnetic flux density Br) of each sample are shown in Table 12.

TABLE 12

| | Amount of Zr | Compacted | | Residual |
|---|---|---|---|---|
| | Powder | Body | | magnetic |
| | Added | Strength | Coecivity Hcj | flux density Br |
| Sample | (mass %) | (MPa) | (kA/m) | (T) |
| 3-14 | 0.00 | 0.50 | 1281 | 1.35 |
| 3-15 | 0.01 | 0.50 | 1283 | 1.35 |
| 3-16 | 0.02 | 0.51 | 1286 | 1.35 |
| 3-17 | 0.05 | 0.51 | 1289 | 1.35 |
| 3-18 | 0.10 | 0.53 | 1299 | 1.35 |
| 3-19 | 0.20 | 0.56 | 1315 | 1.35 |
| 3-20 | 0.50 | 0.64 | 1361 | 1.34 |
| 3-21 | 0.60 | 0.67 | 1342 | 1.33 |
| 3-22 | 1.00 | 0.77 | 1303 | 1.31 |

As is clear from Table 12, the addition of platy Zr powder enables the flexural strength of the compacted body to be enhanced, and it is found that the effect thereof is higher than that in the addition of spherical Zr powder.

Study on Thickness of Platy Zr Powder

Added as the additive metal powder was 0.20 mass % of platy Zr powder. Samples 3-23 to 3-27 were produced, with the thickness of the platy Zr powder varied. The thickness of the platy Zr powder, flexural strength and magnetic properties (coecivity Hcj and residual magnetic flux density Br) of each sample are shown in Table 13.

TABLE 13

| | Planar Zr | | | Residual |
|---|---|---|---|---|
| | Powder | Compacted | | magnetic flux |
| | Thickness | Body Strength | Coecivity Hcj | density Br |
| Sample | (μm) | (MPa) | (kA/m) | (T) |
| 3-23 | 1 | 0.58 | 1320 | 1.35 |
| 3-24 | 3 | 0.56 | 1315 | 1.35 |
| 3-25 | 10 | 0.55 | 1313 | 1.35 |
| 3-26 | 15 | 0.54 | 1310 | 1.35 |
| 3-27 | 20 | 0.54 | 1310 | 1.35 |

As is clear from Table 13, further enhancement in flexural strength is confirmed when the thickness of the platy Zr powder is set at 10 μm or less. Therefore, platy Zr powder having a thickness of 10 μm or less proves effective.

Affection of Addition of Mn Powder (Rectangular Powder) on Compacted Body Strength and Magnetic Properties

In accordance with the production of a rare earth sintered magnet mentioned above, samples 4-1 to 4-9 were produced using arietiform Mn powder as the additive metal powder, with the adding amount thereof varied as shown in Table 14. The amount of the arietiform Mn powder added, flexural strength of the compacted body (compacted body strength) and magnetic properties (coecivity Hcj and residual magnetic flux density Br) are shown in Table 14.

TABLE 14

| | Amount of | | | Residual |
|---|---|---|---|---|
| | Mn Powder | Compacted | | magnetic |
| | Added | Body Strength | Coecivity Hcj | flux density Br |
| Sample | (mass %) | (MPa) | (kA/m) | (T) |
| 4-1 | 0.00 | 0.50 | 1281 | 1.35 |
| 4-2 | 0.01 | 0.50 | 1280 | 1.35 |
| 4-3 | 0.05 | 0.55 | 1277 | 1.35 |
| 4-4 | 0.10 | 0.58 | 1275 | 1.35 |
| 4-5 | 0.20 | 0.55 | 1268 | 1.35 |
| 4-6 | 0.25 | 0.55 | 1262 | 1.34 |
| 4-7 | 0.30 | 0.53 | 1255 | 1.34 |
| 4-8 | 0.50 | 0.51 | 1249 | 1.33 |
| 4-9 | 0.60 | 0.48 | 1202 | 1.31 |

As is clear from Table 14, the addition of Mn enables the flexural strength of the compacted body to be enhanced. The enhancement of the flexural strength comes to the peak around the amount of 0.10 mass % of Mn powder added and shows a slight degradation tendency at the amounts more than that amount. It is, therefore, found that the amount of Mn powder is preferred to be 0.02 mass % or more, more preferably 0.02 mass % to 0.25 mass % inclusive.

Study of Timing of Adding Mn Powder

In accordance with the previous production method, rare earth sintered magnets were produced, with the timing of adding the arietiform Mn powder varied. The amount of the arietiform Mn powder added was 0.10 mass %. The timing of adding the arietiform Mn powder was after the hydrogen crushing (sample 4-10), after crushing by Braun mill (sample 4-11) and after pulverizing by a jet mill (sample 4-12). For the purpose of comparison, a sample having the amount of Mn powder corresponding to the added amount of Mn powder added to the alloy composition (sample 4-13) was also produced. The flexural strength and magnetic properties (coecivity Hcj and residual magnetic flux density Br) of these samples were similarly measured. The results thereof are shown in Table 15.

TABLE 15

| | Amount of | | | Residual |
|---|---|---|---|---|
| | Mn Powder | Compacted | | magnetic |
| | Added | Body Strength | Coecivity Hcj | flux density Br |
| Sample | (mass %) | (MPa) | (kA/m) | (T) |
| 4-10 | 0.10 | 0.55 | 1266 | 1.35 |
| 4-11 | 0.10 | 0.56 | 1270 | 1.35 |
| 4-12 | 0.10 | 0.58 | 1275 | 1.35 |
| 4-13 | *0.10 | 0.50 | 1261 | 1.35 |

*Contained in an alloy composition

As is clear from Table 15, while the compacted body strength is enhanced in any of the samples by the addition of the Mn powder, the effect thereof is enhanced in proportion as the addition is made in a later stage. That is to say, the enhancement in compacted body strength is larger in sample 4-11 than sample 4-10 and larger in sample 4-12 than sample 4-11. Sample 4-13 containing Mn powder in the alloy composition shows no change in compacted body strength as compared with sample 4-1 having no Mn powder added thereto, thus recognizing no effect with respect to the compacted body strength.

Affection of the Addition of Mn Powder (Platy Powder) on Compacted Body Strength and Magnetic Properties

Samples 4-14 to 4-22 were produced, with the adding amount of platy Mn powder varied as shown in Table 16. The thickness of the platy Mn powder used was 3 μm. The amount of platy Mn powder added, flexural strength of the compacted body and magnetic properties (coecivity Hcj and residual magnetic flux density Br) are shown in Table 16.

TABLE 16

| | Amount of | | | Residual |
|---|---|---|---|---|
| | Mn Powder | Compacted | | magnetic |
| | Added | Body Strength | Coecivity Hcj | flux density Br |
| Sample | (mass %) | (MPa) | (kA/m) | (T) |
| 4-14 | 0.00 | 0.50 | 1281 | 1.35 |
| 4-15 | 0.01 | 0.51 | 1281 | 1.35 |
| 4-16 | 0.05 | 0.56 | 1276 | 1.35 |
| 4-17 | 0.10 | 0.63 | 1254 | 1.35 |
| 4-18 | 0.20 | 0.58 | 1268 | 1.35 |
| 4-19 | 0.25 | 0.57 | 1260 | 1.34 |
| 4-20 | 0.30 | 0.55 | 1249 | 1.34 |
| 4-21 | 0.50 | 0.52 | 1248 | 1.33 |
| 4-22 | 0.60 | 0.51 | 1200 | 1.31 |

As is clear from Table 16, while the addition of platy Mn enables the flexural strength of the compacted body to be enhanced, the effect thereof is higher than that in the case of the addition of granular Mn powder.

Study on Thickness of Platy Mn Powder

As the additive metal powder, 0.10 mass % of platy Mn powder was added. Samples 4-23 to 4-27 were produced, with the thickness of the platy Mn powder varied. The thickness of platy Mn powder, flexural strength ad magnetic properties (coecivity Hcj and residual magnetic flux density Br of each sample are shown in Table 17.

TABLE 17

| | Platy Mn | Compacted | | |
|---|---|---|---|---|
| | Powder | Body | | Residual magnetic |
| | Thickness | Strength | Coecivity Hcj | flux density Br |
| Sample | (μm) | (MPa) | (kA/m) | (T) |
| 4-23 | 1 | 0.65 | 1255 | 1.35 |
| 4-24 | 3 | 0.63 | 1254 | 1.35 |
| 4-25 | 10 | 0.62 | 1248 | 1.35 |
| 4-26 | 15 | 0.60 | 1245 | 1.35 |
| 4-27 | 20 | 0.59 | 1244 | 1.35 |

As is clear from Table 17, further enhancement of the flexural strength can be found when the thickness of the platy Mn powder is 10 μm or less. Therefore, it is found that the thickness of platy Mn powder set to 10 μm or less is effective.

Affection of Addition of Various Kinds of Metal Powder on Compacted Body Strength and Magnetic Properties

In accordance with the previous production of rare earth sintered magnet, samples 5-1 to 5-8 were produced using additive metal powders shown in Table 18. The amount of the metal powders added was 0.1 mass %, and particle size was 10 to 20 μm (spherical powders). The kind and amount of the powders added, flexural strength of the compacted body (compacted body strength) and magnetic propertiese (coecivity Hcj and residual magnetic flux density Br of each sample are shown in Table 18.

TABLE 18

| | Kind of | | Compacted | | Residual |
|---|---|---|---|---|---|
| Sam- | Metal | Amount | Body Strength | Coecivity | magnetic flux |
| ple | Powder | Added | (MPa) | Hcj (kA/m) | density Br (T) |
| 5-1 | None | 0.00 | 0.50 | 1281 | 1.35 |
| 5-2 | Fe | 0.10 | 0.53 | 1270 | 1.34 |
| 5-3 | Co | 0.10 | 0.53 | 1275 | 1.34 |
| 5-4 | Cu | 0.10 | 0.54 | 1300 | 1.34 |
| 5-5 | Zn | 0.10 | 0.53 | 1285 | 1.35 |
| 5-6 | Ag | 0.10 | 0.53 | 1304 | 1.34 |
| 5-7 | Sn | 0.10 | 0.52 | 1298 | 1.34 |
| 5-8 | Bi | 0.10 | 0.53 | 1311 | 1.34 |

As is clear from Table 18, the flexural strength of the compacted body is enhanced through the addition of various metal powders. It is, therefore, found that the addition of metal powder before compacting in a magnetic field is effective.

1. A method for producing a rare earth sintered magnet, comprising the steps of preparing pulverized raw alloy that comprises R (R is at least one rare earth element, provided that it contains Y), T (T is at least one transition metal element indispensably containing Fe or Fe and Co) and B and has additive metal powder added thereto, compacting the prepared pulverized raw alloy to obtain a compacted body and sintering the compacted body.

2. A method for producing a rare earth sintered magnet according to claim 1, further comprising a process of crushing the raw alloy and a process of pulverizing the crushed raw alloy and wherein the additive metal powder is added after the process of pulverizing.

3. A method for producing a rare earth sintered magnet according to claim 1, further comprising a process of crushing the raw alloy and a process of pulverizing the crushed raw alloy and wherein the additive metal powder is added after the process of crushing.

4. A method for producing a rare earth sintered magnet according to claim 1, further comprising a process of crushing the raw alloy and a process of pulverizing the crushed raw alloy, wherein the process of crushing comprises a hydrogen crushing process and a mechanical crushing process and wherein the additive metal powder is added after the hydrogen crushing process.

5. A method for producing a rare earth sintered magnet according to claim 1, wherein the additive metal powder is at least one species selected from the group consisting of powders of Al, Ni, Zr, Mn, Fe, Co, Cu, Zn, Ag, Sn and Bi.

6. A method for producing a rare earth sintered magnet according to claim 1, wherein the additive metal powder is platy metal powder.

7. A method for producing a rare earth sintered magnet according to claim 5, wherein the platy metal powder has a thickness of 10 μm or less.

8. A method for producing a rare earth sintered magnet according to claim 5, wherein the platy metal powder has a thickness of 3 μm or less.
